(19) United States
(12) Patent Application Publication
(10) Pub. No.: US 2005/0176251 A1
(43) Pub. Date: Aug. 11, 2005

(54) Polishing pad with releasable slick particles

(76) Inventor: Chau H. Duong, Newark, DE (US)

Correspondence Address: Rohm and Haas;Electronic Materials CMP Holdings, Inc., Suite 1300, 1105 North Market Street, Wilmington, DE, 19899, US

(21) Appl. No.: 10/774,656

(22) Filed: Feb. 5, 2004

(51) Int. Cl. B44C 1/22

(52) U.S. Cl. 438/692; 216/89

(57) ABSTRACT

The present invention provides a polishing pad useful for polishing a semiconductor substrate, the polishing pad comprising: a polishing layer having a polishing surface, the polishing layer comprising particles disposed in a polymeric matrix, the particles being coated with a material having a surface tension of less than 50 dynes/cm, the coated particles being capable of releasing from the polishing surface during polishing.

### BACKGROUND OF THE INVENTION

The present invention relates to polishing pads for chemical mechanical planarization (CMP), and in particular, relates to polishing pads having releasable, slick particles.

In the fabrication of integrated circuits and other electronic devices, multiple layers of conducting, semiconducting and dielectric materials are deposited on or removed from a surface of a semiconductor wafer. Thin layers of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and electrochemical plating (ECP).

As layers of materials are sequentially deposited and removed, the uppermost surface of the wafer becomes non-planar. Because subsequent semiconductor processing (e.g., metallization) requires the wafer to have a flat surface, the wafer needs to be planarized. Planarization is useful in removing undesired surface topography and surface defects, such as rough surfaces, agglomerated materials, crystal lattice damage, scratches, and contaminated layers or materials.

Chemical mechanical planarization, or chemical mechanical polishing (CMP), is a common technique used to planarize substrates, such as semiconductor wafers. In conventional CMP, a wafer carrier is mounted on a carrier assembly and positioned in contact with a polishing pad in a CMP apparatus. The carrier assembly provides a controllable pressure to the wafer, pressing it against the polishing pad. The pad is optionally moved (e.g., rotated) relative to the wafer by an external driving force. Simultaneously therewith, a chemical composition (“slurry”) or other fluid medium is flowed onto the polishing pad and into the gap between the wafer and the polishing pad. Thus, the wafer surface is polished and made planar by the chemical and mechanical action of the pad surface and slurry.

Importantly, once the material removal rate drops to a predetermined value, a polishing pad must be conditioned to restore its full functionality. Pad conditioning may be performed by exposing the polishing pad to a sonically agitated stream of fluid with or without chemical additive, or conditioning may be performed by rubbing a hard abrasive surface against the polishing pad to remove embedded debris and to restore a desired degree of roughness and porosity to the polishing pad surface. Pad conditioners may be, for example, metal plates having industrial diamonds affixed to their surface. In a typical CMP operation, a polishing pad may have to be conditioned after polishing only a few wafers, consuming additional critical path time during the fabrication process and negatively impacting the overall productivity of a semiconductor manufacturing line.

James et al., in U.S. Pat. No. 6,069,080, discloses a fixed-abrasive polishing pad containing abrasive particles in an attempt, amongst others, to minimize conditioning. Unfortunately, the abrasive particles may negatively interact with the surface to be polished. In other words, the abrasive particles may cause unwanted fracturing or scratching.

Hence, what is needed is a polishing pad that provides improved planarization while requiring minimal conditioning. In particular, what is needed is a polishing pad that requires minimal conditioning while providing a smooth, scratch-free polished surface.

### STATEMENT OF THE INVENTION

In a first aspect of the present invention, there is provided a polishing pad useful for polishing a semiconductor substrate, the polishing pad comprising: a polishing layer having a polishing surface, the polishing layer comprising particles disposed in a polymeric matrix, the particles being coated with a material having a surface tension of less than 50 dynes/cm, the coated particles being capable of releasing from the polishing surface during polishing.

In a second aspect of the present invention, there is provided a polishing pad useful for polishing a semiconductor substrate, the polishing pad comprising: a polymeric matrix having calcium carbonate particles disposed therein, the particles being coated with tetrafluoroethylene, the coated particles being capable of releasing from the polishing pad during polishing.

In a third aspect of the present invention, there is provided a polishing pad useful for polishing a semiconductor substrate, the polishing pad comprising: a polishing layer having a polishing surface, the polishing layer comprising non-abrasive particles disposed in a polymeric matrix, the non-abrasive particles having a surface tension of less than 50 dynes/cm, the non-abrasive particles being capable of releasing from the polishing surface during polishing.

In a fourth aspect of the present invention, there is provided a method of chemical mechanical polishing a semiconductor substrate, comprising: providing a polishing fluid between the substrate and a polishing pad; providing relative motion and pressure between the substrate and the polishing pad, wherein the polishing pad comprises: a polishing layer having a polishing surface, the polishing layer comprising particles disposed in a polymeric matrix, the particles being coated with a material having a surface tension of less than 50 dynes/cm, the coated particles being capable of releasing from the polishing surface during polishing.

### BRIEF DESCRIPTION OF THE DRAWINGS

FIG. 1 is a partial cross-sectional view of a polishing pad of the present invention;

FIG. 2 is an exploded view of a slick particle of the present invention;

FIG. 3 is an exploded view of another embodiment of the slick particle of the present invention; and

FIG. 4 is a partial schematic diagram and partial perspective view of a chemical mechanical polishing (CMP) system utilizing the polishing pad of the present invention.

### DETAILED DESCRIPTION OF THE INVENTION

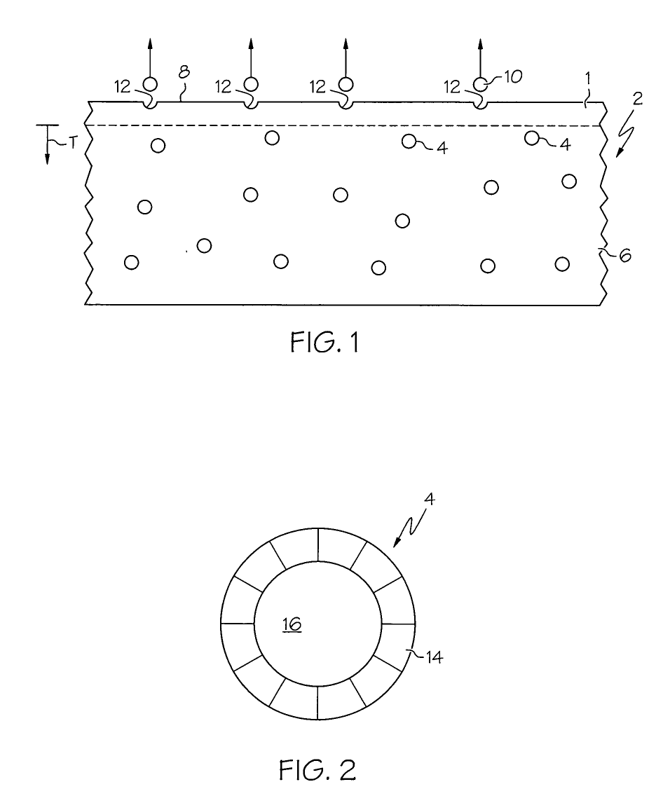

Referring now to the drawings, FIG. 1 discloses a polishing pad 2 having a polishing layer 1 and having a plurality of slick particles 4 embedded in a matrix material 6. Polishing pad 2 provides a desired degree of roughness and porosity for accomplishing a wafer polishing operation regardless of the state of wear of the polishing pad 2. Slick particles 4 are continuously distributed throughout a thickness T of the polishing pad 2 within the matrix material 6. The matrix material 6 may comprise a thermoplastic material, for example, a thermoplastic polyurethane, polyvinyl chloride, ethylene vinyl acetate, polyolefin, polyester, polybutadiene, ethylene-propylene terpolymer, polycarbonate and polyethylene teraphthalate, and mixtures thereof. In addition, matrix material 6 may comprise a thermoset material, for example, a cross-linked polyurethane, epoxy, polyester, polyimide, polyolefin, polybutadiene and mixtures thereof The matrix material 6 may be selected to have a desired degree of elasticity, porosity, density, hardness, etc. in order to provide a predetermined polishing and wear performance in conjunction with the selected slick particles 4.

As T is reduced, a different population of slick particles 4 will become exposed at the polishing surface 8. Note, although illustrated in two dimensions in FIG. 1, one may appreciate that the matrix material 6 defines a three-dimensional micro-grid or mesh for supporting a three-dimensional array of slick particles 4. Slick particles 4 may be distributed evenly or randomly throughout the matrix material 6 in order to provide consistent polishing properties across the thickness T of the pad 2. Alternatively, a systematic array of coated particles 4 may be desired, with variations in the distribution of the slick particles 4 possible through the thickness T or across a diameter of the polishing surface 8. In another embodiment, there may be more slick particles 4 per unit volume of matrix material 6 as a function of the pad depth T. The number of slick particles 4 per unit volume may be selected in conjunction with the specification of the other pad properties in order to achieve a desired material removal performance for a particular application.

As polishing surface 8 is used to polish one or more semiconductor wafers, a top portion of the polishing layer 1 is spent and the uppermost slick particles 4 will be released, thereby creating voids 12 and restoring a degree of roughness and porosity to the polishing surface 8. In this way, the polishing surface 8 requires minimal conditioning, if any. Also, in practice, the released particles 10 may simply be washed away with the spent slurry.

Advantageously, the polishing pad 2 comprises 20 to 90 weight percent slick particles 4. Within this range, it is desirable to have the slick particles 4 present in an amount of greater than or equal to 50 weight percent. Also, desirable within this range is an amount of less than or equal to 80 weight percent. In a preferred embodiment of the invention, slick particle 4 has an average particle size of between 0.5 to 400 microns. More preferably, it is desirable to use a slick particle 4 having an average particle size of between 10 to 50 microns.

Referring now to FIG. 2, the slick particle 4 comprises a material 14 that encapsulates or coats a particle 16. In an exemplary embodiment of the invention, the material 14 advantageously has a surface tension of less than 50 dynes/cm. Preferably, the material 14 has a surface tension of less than 30 dynes/cm. Note, the surface tension of the material 14 is largely determinative of the surface tension of the coated, slick particle 4. Accordingly, for the purposes of this specification, the surface tension of the slick particle 4 is considered to be equal to that of the material 14. The provided surface tension allows the slick particle 4 to be lubricious and does not interfere with the polishing process. In other words, the coated particle 4 is non-abrasive and causes insignificant fracturing or scratching, if any. In a preferred embodiment of the present invention, the material 14 may comprise stearic acid, calcium stearate, silicon tetrahydride, tetrafluoroethylene, zinc stearate and mixtures thereof. Preferably, material 14 is tetrafluoroethylene. The material 14 may be provided on the particle 16 by various techniques, for example, spray coating or spray drying.

Particle 16 may comprise inorganic oxides, inorganic hydroxides, inorganic hydroxide oxides, organic oxides, organic hydroxides, organic hydroxide oxides, metal borides, metal carbides, metal nitrides, polymer particles and mixtures comprising at least one of the foregoing. Suitable inorganic oxides include, for example, silica (SiO₂), alumina (Al₂O₃), zirconia (ZrO₂), ceria (CeO₂), manganese oxide (MnO₂), titanium oxide (TiO₂) or combinations comprising at least one of the foregoing oxides. Suitable inorganic hydroxides include, for example, aluminum hydroxide oxide (“boehmite”). Suitable metal carbides, boride and nitrides include, for example, silicon carbide, silicon nitride, silicon carbonitride (SiCN), boron carbide, tungsten carbide, zirconium carbide, aluminum boride, tantalum carbide, titanium carbide, or combinations comprising at least one of the foregoing metal carbides, boride and nitrides. Preferably, particle 16 is calcium carbonate.

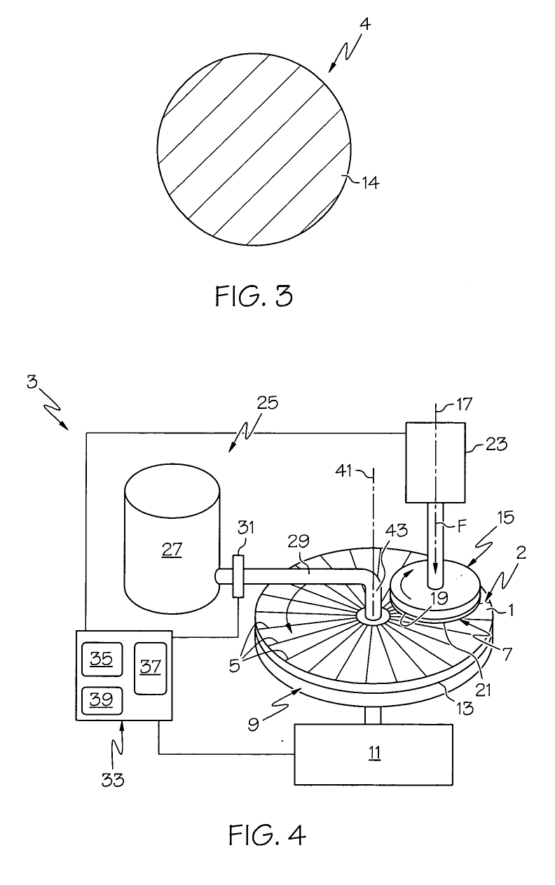

In another embodiment of the present invention, FIG. 3 illustrates the slick particle 4 wholly comprised of material 14. In this embodiment, material 14 and the particle 16 (of FIG. 2) are the same. In other words, material 14 does not coat a particle (as in FIG. 2), but, rather, the material 14 is the slick particle 4. In a preferred embodiment of the present invention, the material 14, as in FIG. 2, may comprise stearic acid, calcium stearate, silicon tetrahydride, tetrafluoroethylene, zinc stearate and mixtures thereof. In an exemplary embodiment of the invention, the material 14 advantageously has a surface tension of less than 50 dynes/cm. Preferably, the material 14 has a surface tension of less than 30 dynes/cm. As discussed above, for the purposes of this specification, the surface tension of the slick particle 4 is considered to be equal to that of the material 14. Also, the provided surface tension allows the slick particle 4 to be lubricious and does not interfere with the polishing process. In other words, the slick particle 4 is non-abrasive and causes insignificant fracturing or scratching, if any.

Hence, there is provided a polishing pad useful for polishing a semiconductor substrate and requires minimal conditioning, if any, and is cost effective to utilize. In one embodiment of the invention, the polishing pad comprises particles disposed in a polymeric matrix and being coated with a material having a surface tension at least less than 50 dynes/cm. The coated particles are capable of releasing from the polishing surface of the polishing layer during polishing. In this way, as the top portion of the polishing layer is spent, the uppermost slick particles in the polishing layer will be released, thereby creating voids and restoring a degree of roughness and porosity to the polishing surface without abrading or scratching the surface to be polished.

Referring now to FIG. 4, a chemical mechanical polishing (CMP) system 3, utilizing the polishing pad 2 of the present invention is illustrated. CMP system 3 includes a polishing pad 2 having a polishing layer 1 that includes a plurality of grooves 5 (not shown) arranged and configured for enhancing the utilization of a slurry 43, or other liquid polishing medium, applied to the polishing pad 2 during polishing of a semiconductor substrate, such as a semiconductor wafer 7 or other workpiece, such as glass, silicon wafers and magnetic information storage disks, among others. For convenience, the term “wafer” is used in the description below. However, those skilled in the art will appreciate that workpieces other than wafers are within the scope of the present invention.

CMP system 3 may include a polishing platen 9 rotatable about an axis 41 by a platen driver 11. Platen 9 may have an upper surface 13 on which polishing pad 2 is mounted. A wafer carrier 15 rotatable about an axis 17 may be supported above polishing layer 1. Wafer carrier 15 may have a lower surface 19 that engages wafer 7. Wafer 7 has a surface 21 that faces polishing layer 1 and is planarized during polishing. Wafer carrier 15 may be supported by a carrier support assembly 23 adapted to rotate wafer 7 and provide a downward force F to press wafer surface 21 against polishing layer 1 so that a desired pressure exists between the wafer surface 21 and the polishing layer 1 during polishing.

CMP system 3 may also include a slurry supply system 25 for supplying slurry 43 to polishing layer 1. Slurry supply system 25 may include a reservoir 27, e.g., a temperature controlled reservoir, that holds slurry 43. A conduit 29 may carry slurry 43 from reservoir 27 to a location adjacent polishing pad 2 where the slurry is dispensed onto polishing layer 1. A flow control valve 31 may be used to control the dispensing of slurry 43 onto pad 2.

CMP system 3 may be provided with a system controller 33 for controlling the various components of the system, such as flow control valve 31 of slurry supply system 25, platen driver 11 and carrier support assembly 23, among others, during loading, polishing and unloading operations. In the exemplary embodiment, system controller 33 includes a processor 35, memory 37 connected to the processor, and support circuitry 39 for supporting the operation of the processor, memory and other components of the system controller.

During the polishing operation, system controller 33 causes platen 9 and polishing pad 2 to rotate and activates slurry supply system 25 to dispense slurry 43 onto the rotating polishing pad 2. The slurry spreads out over polishing layer 1 due to the rotation of polishing pad 2, including the gap between wafer 7 and polishing pad 2. System controller 33 may also cause wafer carrier 15 to rotate at a selected speed, e.g., 0 rpm to 150 rpm, so that wafer surface 21 moves relative to the polishing layer 1. System controller 33 may further control wafer carrier 15 to provide a downward force F so as to induce a desired pressure, e.g., 0 psi to 15 psi, between wafer 7 and polishing pad 2. System controller 33 further controls the rotational speed of polishing platen 9, which is typically rotated at a speed of 0 to 150 rpm.

1. A polishing pad useful for polishing a semiconductor substrate, the polishing pad comprising: a polishing layer having a polishing surface, the polishing layer comprising particles disposed in a polymeric matrix, the particles being coated with a material having a surface tension of less than 50 dynes/cm, the coated particles being capable of releasing from the polishing surface during polishing.

2. The polishing pad of claim 1, wherein the polishing pad comprises by weight percent 20 to 90 coated particles.

3. The polishing pad of claim 1, wherein the coated particle has an average particle size of 0.5 to 400 microns.

4. The polishing pad of claim 1, wherein the material has a surface tension of less than 30 dynes/cm.

5. The polishing pad of claim 1, wherein the material is selected from the group comprising: stearic acid, calcium stearate, silicon tetrahydride, tetrafluoroethylene and zinc stearate and mixtures thereof.

6. The polishing pad of claim 1, wherein the polymeric matrix is selected from the group comprising: thermoplastic and thermoset materials.

7. The polishing pad of claim 1, wherein the particle is selected from the group comprising: inorganic oxides, inorganic hydroxides, inorganic hydroxide oxides, organic oxides, organic hydroxides, organic hydroxide oxides, metal borides, metal carbides, metal nitrides, polymer particles and mixtures thereof.

8. A polishing pad useful for polishing a semiconductor substrate, the polishing pad comprising: a polymeric matrix having calcium carbonate particles disposed therein, the particles being coated with tetrafluoroethylene, the coated particles being capable of releasing from the polishing pad during polishing.

9. A polishing pad useful for polishing a semiconductor substrate, the polishing pad comprising: a polishing layer having a polishing surface, the polishing layer comprising non-abrasive particles disposed in a polymeric matrix, the non-abrasive particles having a surface tension of less than 50 dynes/cm, the non-abrasive particles being capable of releasing from the polishing surface during polishing.

10. A method of chemical mechanical polishing a semiconductor substrate, comprising:
providing a polishing fluid between the substrate and a polishing pad;
providing relative motion and pressure between the substrate and the polishing pad, wherein the polishing pad comprises: a polishing layer having a polishing surface, the polishing layer comprising particles disposed in a polymeric matrix, the particles being coated with a material having a surface tension of less than 50 dynes/cm, the coated particles being capable of releasing from the polishing surface during polishing.
